(19) United States
(12) Patent Application Publication
(10) Pub. No.: US 2014/0089308 A1
(43) Pub. Date: Mar. 27, 2014

(54) Tracking Documents in Computing Devices

(71) Applicant: INTERNATIONAL BUSINESS MACHINES CORPORATION, Armonk, NY (US)

(72) Inventors: Arun Ramakrishnan, Tamil Nadu (IN); Rohit Shetty, Bangalore KAR (IN)

(73) Assignee: INTERNATIONAL BUSINESS MACHINES CORPORATION, Armonk, NY (US)

(21) Appl. No.: 13/627,413

(22) Filed: Sep. 26, 2012

(51) Int. Cl. G06F 17/30

(52) U.S. Cl. 707/736; 707/E17.008

(57) ABSTRACT

A method and system for tracking documents in computing devices is provided. The method includes creating a unique identifier for a document in a computing device based on contents of the document and meta-data associated with the document. The unique identifier is then used for tracking the document in one or more computing devices. The tracking of the document can be done for all the documents in plurality of computing devices. The method further tracks propagation of the document in the plurality computing devices.

### BACKGROUND

1. Technical Field

The embodiment of the invention relates generally to tracking systems and particularly to file tracking systems.

2. Description of Related Art

As an organization grows in size, large amounts of information is created and shared between members of the organization. Generally, such information is available in various forms of documents like word processor documents, presentation documents, image files, spreadsheets and the like. These documents are processed by various members at various stages in the organization. The processing of documents includes but is not limited to sharing, reviewing, creation, and updating of the documents. There are various ways for sharing the document in the organization, amongst which email is generally a most popular mode of sharing. Sharing of the documents also results in numerous copies and version of the documents and such documents will be available in disparate locations. Since the documents can be shared and re-shared again, it becomes very difficult for the organization or document author to track or to be aware of the extent of the document's reach. This may lead to concerns like information security, information isolation and redundancy.

The process of sharing the documents can lead to inconsistent information with different members of the organization. Currently, there is no way for an author of a document to track the propagation of the document between various users and thereafter contact or communicate with the other members of the organization who possess the particular document. Similarly, there is no way for someone who possesses the document to be aware of the state of the document in terms of document updates and versions.

Hence, there exists a need to efficiently manage tracking of documents in organizations.

### SUMMARY OF THE INVENTION

According to one embodiment of the present invention, a computer implemented method for tracking documents in a plurality of computing devices is provided. The method includes creating a unique identifier for a document in a computing device based on contents of the document and meta-data associated with the document. Thereafter, the method tracks the document in one or more computing devices based on the unique identifier.

According to another embodiment of the present invention, a computer system for tracking documents in a plurality of computing devices is provided. The computer system comprises one or more processors that include program instructions to create a unique identifier for a document in a computing device based on contents of the document and meta-data associated with the document. The one or more processors include further instructions to track the document in one or more computing devices based on the unique identifier.

According to yet another embodiment of the present invention, a computer program product for tracking documents in a plurality of computing devices is provided. The computer program product includes one or more computer-readable tangible storage devices and program instructions stored on at least one or more storage devices. The storage device includes program instructions to create a unique identifier for a document in a computing device based on contents of the document and meta-data associated with the document. The storage device also includes program instructions to track the document in one or more computing devices based on the unique identifier.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims

### BRIEF DESCRIPTION OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates an exemplary environment that includes block diagram for tracking creation of documents, modification of documents and sharing of documents, in accordance with one embodiment of the present invention;

FIG. 2 illustrates an exemplary flow diagram for tracking propagation of documents within the scope of the document tracker and outside the scope of the document tracker, in accordance with one embodiment of the present invention;

FIG. 3 illustrates an exemplary graph structure of different document versions and document authors, in accordance with one embodiment of the present invention;

FIG. 4 illustrates a working of a document tracking agent associated with a document source in accordance with one embodiment of the present invention; and

FIG. 5 illustrates a high level logic flowchart for tracking documents in plurality of computing devices in accordance with one embodiment of the present invention.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

The description now turns to the figures. The one or more embodiments of the invention may be understood by reference to the figures. The following description is intended only by way of example and simply illustrates one or more embodiments of the invention as claimed herein.

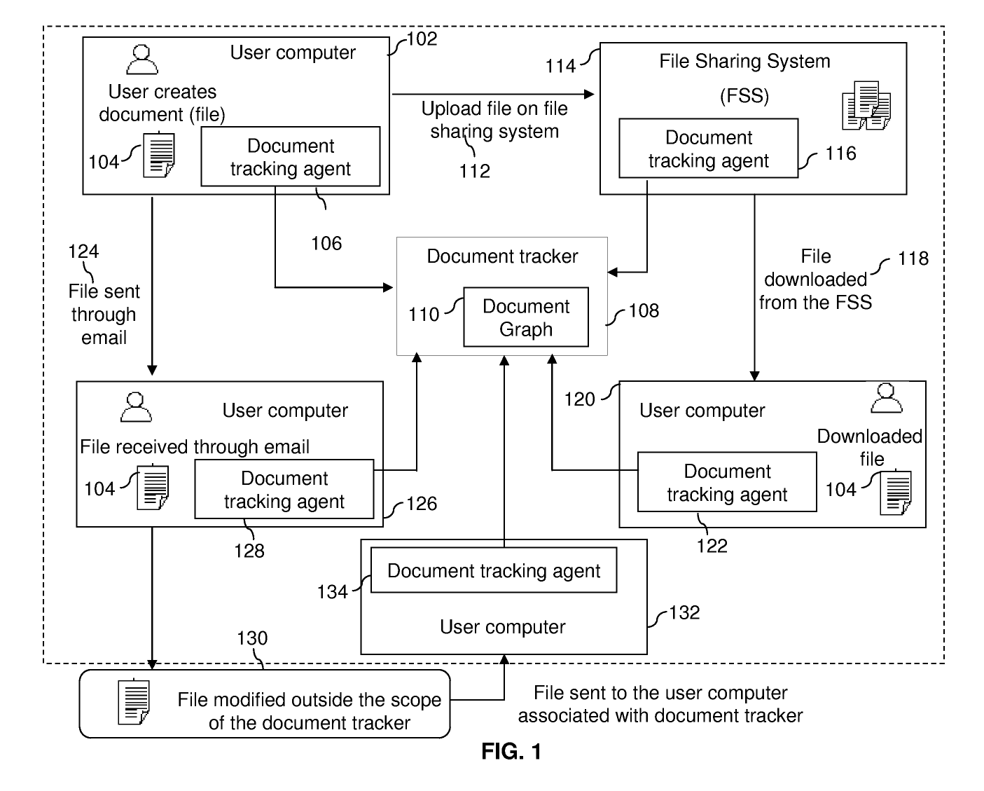

FIG. 1 illustrates an exemplary environment 100 that includes a block diagram of a system for tracking creation of documents, modification of documents and sharing of documents. The block diagram in the environment 100 is shown to include document creation, sharing and modification within a boundary of a document tracker and outside the boundary of the document tracker. The documents are tracked whenever they are created, modified or shared by the authors of the documents or other users. The documents are tracked even when they are propagated to other users or received by other users.

In an embodiment, the document tracker is a software module that is installed in a computing device or is associated with the computing devices to track creation of documents, sharing of documents and updates performed in the documents. The environment 100 is shown to include individual users who are responsible for creation of information in various forms of documents and then propagating or sharing the documents across an organization through a variety of methods using document sources. The document sources include, but are not limited to, user computers, file sharing systems, emails, archives, and document control systems. In the environment 100, the document sources are user computer 102, user computer 114, user computer 120, and user computer 126. In an embodiment, the document sources are the sources where the documents reside.

In an embodiment, the documents that are created and propagated can be uniquely identifiable across document sources through the use of hashes or using other forms of unique identifiers. In an embodiment, the document is uniquely identified using tracking agents, for example, tracking agents 106, 116, 122, and 128. In an embodiment, the tracking agents reside on the document sources and track any changes made to the documents, sharing of the documents and creation of the documents. In an embodiment, the tracking agent(s) creates a unique document identifier for each document and pushes the created document identifiers to a document tracker, for example, document tracker 108.

In an embodiment, the tracking agents, for example the tracking agents 106, 116, 122, and 128 creates unique document identifiers based on predefined rules, document formats, document contents and meta-data associated with the document. Thus, each tracking agent creates a similar unique document identifier for similar documents. In an embodiment, the document tracker 108 is also responsible for keeping track of various document identifiers and the changing document identifiers as a result of the documents being modified. In addition to this, the document tracker 108 also tracks the document authors and the locations of the documents. In an embodiment, the document tracker maintains a graph, for example a document graph 110, which includes document versions, their corresponding authors and locations. Thus, the evolution of a document starting from its initial author is tracked in the document tracker 108 in the form of the document graph 110.

The block diagram as shown in the environment 100 can be explained using the following example. A user of the computer 102 initially creates a document 104. The tracking agent 106 then pushes this information to the document tracker 108. Hence, as and when the document is created or modified on document sources, the tracking agents residing on the document sources create unique identities and push the unique identifiers to the document tracker 108. Thus, the tracking agent 106 analyzes the document 104 and creates a unique identifier (hereinafter also referred to as a document identifier) for the document based on the internal contents of the document, meta-data and predefined rules. The document's unique document identifier is then pushed to the document tracker 108 along with the name of the authors of the document or the computing device.

At step 112, the user of the user computer 102 uploads the file 104 on the file sharing system 114. The file sharing system 114 is associated with the tracking agent 116. The tracking agent 116 creates a unique identifier associated with the file 104 using the document contents, meta-data and the predefined rules. In an embodiment, each tracking agent is associated with the same predefined rules to identify similar identifiers associated with the documents. The tracking agent 116 will then send the unique identifier associated with the uploaded document to the document tracker 108 along with the document author information.

At step 118, the file 104 is downloaded by the user computer 120 from the file sharing system 114. When the document is downloaded in the user computer 118, the tracking agent 122 creates a unique identifier associated with the downloaded document, for example the file 104. The tracking agent 122 thereafter sends the document identifiers of the document along with the user name, for example the current document authors, to the document tracker 108. At step 124, the user of the computer 102 and further sends the document 104 to the user computer 126. The document tracking agent 128 associated with the user computer 126 will then identify and create the unique identifiers in a similar fashion as explained earlier and then similarly sends the unique identifiers to the document tracker 108 along with the user/author name.

In the environment 100, at step 130 the file is modified outside the scope of the document tracker. The document is considered to be modified outside the scope of the document tracker 108 when the document is modified by the computing device that is not directly associated with the document tracker 108. The file 104 after being modified outside the scope of the document tracker is sent to the user computer 132 that is associated with the document tracker 108. The tracking agent 134 will then track the document and will create the unique identifier associated with the document 104. The unique identifier is then uploaded with the details of the users on the document tracker 108.

The computing devices associated with the same document 104 can be mapped with each other as the unique identifier created by the computing devices for the document 104 remains same with every computing device. In an embodiment, the document tracker 108 will create the document graph 114 associated with the document 104. The document graph 114 will include a pictorial representation of all the users of the document 104 and the modified version details of the document 104. Hence, the document tracker 108 relates shared documents of the organization using identifiers, document locations and author information sent by tracking agents associated with each document sources. Thus, the document author will be able to connect to all the users that have a particular document and can track propagation and modification of the document, for example the document 104 or a modified version of the document 104.

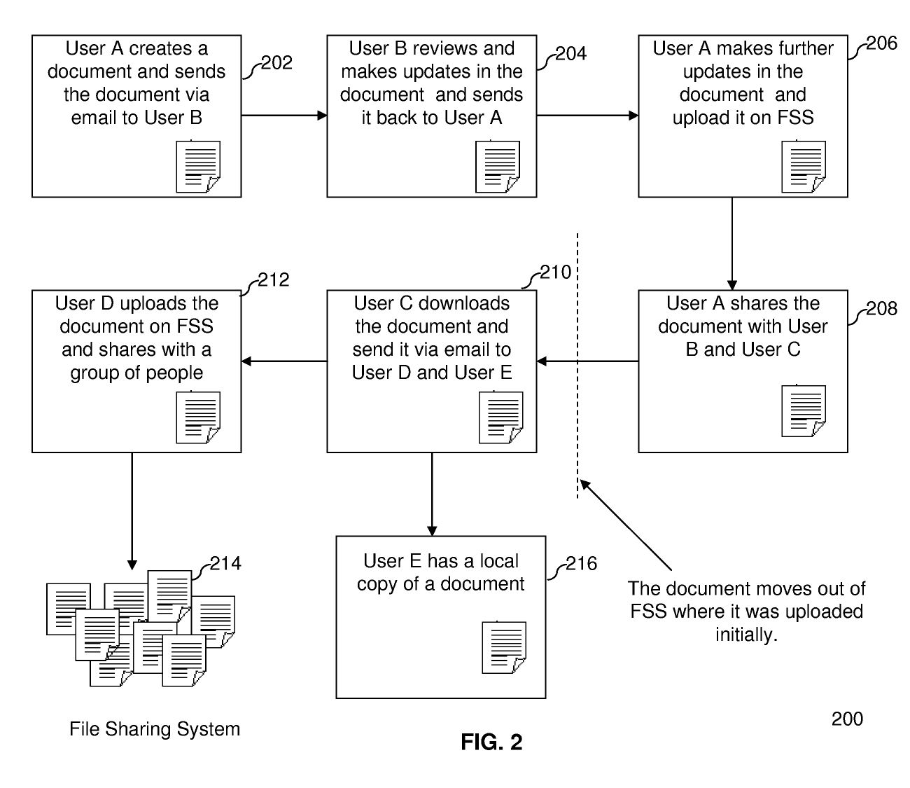

FIG. 2 illustrates an exemplary flow diagram for tracking propagation of a document within the scope of the document tracker and outside the scope of the document tracker. At step 202, a user, for example a user A, creates a document and sends the document via email to a user B. As the user A creates the document, the document tracking agent associated with the document source of the user A is initiated and tracks the creation of the document. The tracking agent then creates a unique document identifier associated with the created document and sends the unique identifier to the document tracker along with the user A details.

At step 204, the user B reviews the received document and thereafter makes updates in the document. The document is then sent back to the user A. While performing the step 204, the tracking agent associated with the document source of the user B extracts identifiers associated with the received document and then sends the document identifiers along with user B details to the document tracker. In an embodiment, the tracking agent also identifies the document with different version number when the document is modified by the user. At step 206, the user A makes further updates in the document and uploads it onto a File Sharing System (FSS).

At step 208, the user A shares the document with the user B and user C. Hence, the user B and user C can now access or modify the shared document. In an embodiment, the document moves out of the FSS where it was uploaded initially by the user A. At step 210, the user C downloads the document and thereafter sends the document via email to user D and user E. Hence, the tracking agents associated with computing devices of the user C update the document tracker with document identifiers and user C details. At step 212, user D uploads the document on a FSS 214 and shares with a group of people. Thus, the tracking agent associated with the computing device of user D creates the unique identifiers and then updates the document tracker with user D details, unique identifier and the version of the document. At step 216, user E keeps a local copy of a document. The tracking agent associated with the computing device of user E then creates and sends the unique document identifier along with user E details to the document tracker.

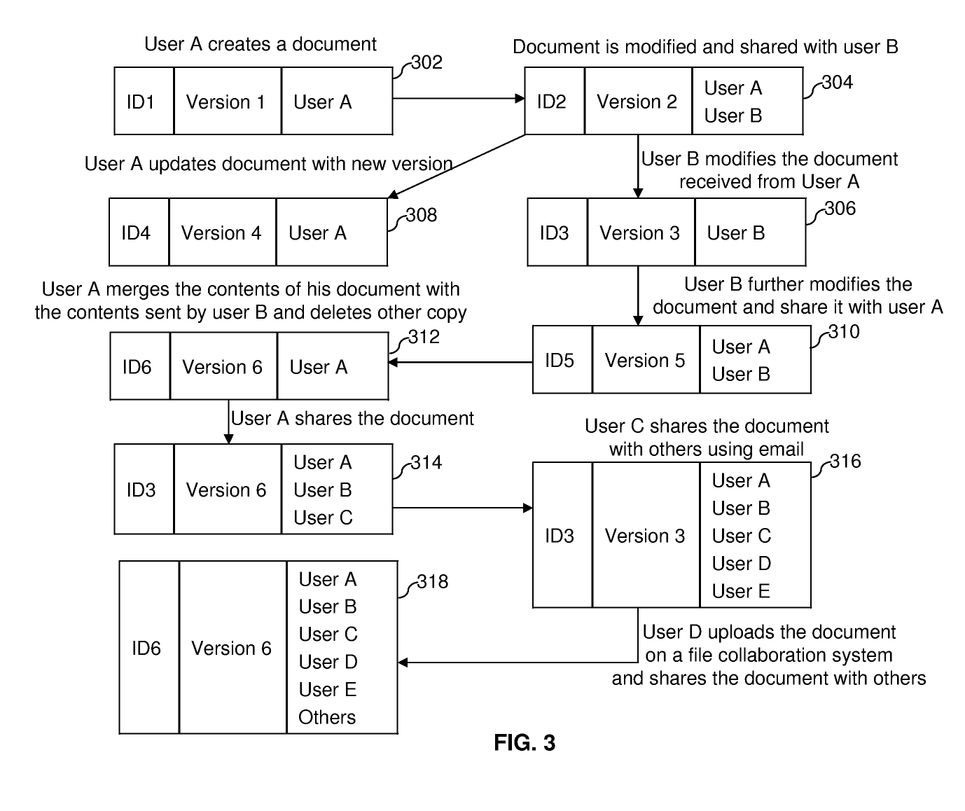

Hence, at each step of document sharing process, the tracking agent is responsible for watching any changes made in documents and thereafter notifying the document tracker with document identifiers. In the above mentioned example, when user A creates a document, the document tracker is notified with document identifiers and user details like the name of the authors of the document, for example user A. Thereafter, when the document reaches user B through email, the tracking agent on user B then creates the unique identifier and thereafter sends unique identifier, version of the document and the user E details to the document tracker. In spite of the document being shared through email (or even a file transfer on a chat program), since the document identifiers match, the document tracker is aware that user A and user B have the document in common. The document tracker would typically maintain the documents in a graph like structure allowing the document tracker to relate various versions of the document with their authors. The document graph like structure is explained in conjunction with FIG. 3.

FIG. 3 illustrates an exemplary graph structure of a document in a document tracker in accordance with one embodiment of the present invention. A structure 302 is created when a user A creates a document, adds information in the document, sends the document to other users or receives the document from other users. In response to the action performed by the user, the tracking agent creates a unique identifier associated with the document and thereafter associates a version with the document along with user details. Hence, the structure 302 includes three sections wherein the first section includes the document identifier associated with the created document, for example ID1, the second section includes version number, for example version 1, and the third section includes the author/user details, for example user A.

The user A then modifies the document and shares it with user B through email and based on this activity of the user A, a structure 304 is created. The modified document is now associated with the user A and the user B. Thus, the structure 304 includes a value ID2 in the unique identifier field, a Version 2 in the version field and the user details as user A and user B in the document author fields. The user B then modifies the document received from the user A and thus a structure 306 is created. As the document is modified by the user B, a new version of the document and a new identifier value is updated in the structure 306. Hence, the structure 306 includes a value as ID3 in the unique identifier field, Version 3 in the version field and user B in the user details field. A structure 308 is created when the user A updates the version 3 of the document and creates a newer version of the document. Hence the structure 308 includes ID4, Version 4 and user A in the three fields of the structure 308.

A structure 310 is created when the user B further modifies the document and shares it with the user A. In the structure 310, the document author field is updated with user A and user B and a new identifier and a new version is updated in the identifier and the version field, as the version 3 of the document is modified by the user B. Thus, the three fields in the structure 310 includes, a value ID5 in the unique identifier field, Version 5 in the version field and the user A and user B in the document author field. The user A then merges the contents of the document stored in his/her system with the contents received from the user B and further deletes the older copy associated with version 4, based on this activity a structure 312 is created. The structure 312 includes identifier as ID6, version as Version 6 and the author of the document as user A.

A structure 314 is created when the user A shares the version 6 of the document with other users using a file collaboration system. The structure 316 includes the same identifier and version as the structure 312 because the document is only shared and not modified and the user/author field will include the details of the user with whom the document is shared, for example the user B and user C. Hence, the structure 314 includes identifier and version as ID6 and Version 6, respectively, and the user field includes user A, user B and user C as document authors.

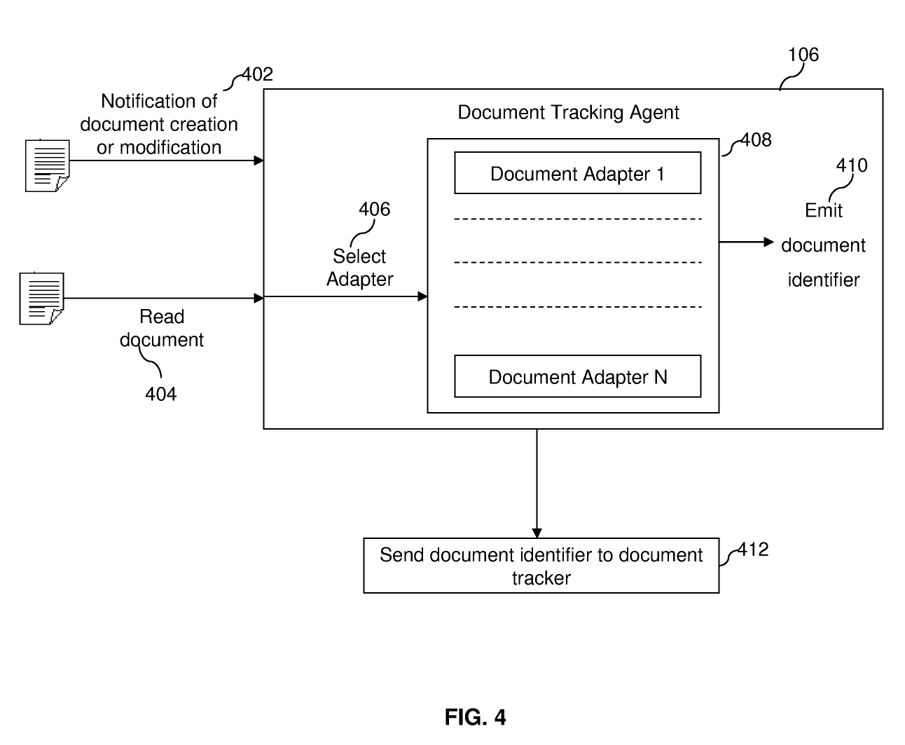

FIG. 4 illustrates a working of a document tracking agent associated with a document source in accordance with one embodiment of the present invention. At step 402, the document tracking agent, for example the document tracking agent 106, receives a notification when a document is created, modified, shared, sent to another computer or received in an associated document source. An example of the associated document source is a user computer where the document is created, modified or shared. At step 404, the document tracking agent 106 reads the document.

At step 406, the document tracking agent 106 selects one or more adapters from a list of adapters 408 associated with the document tracking agent 106. The one or more adapters are selected based on the type of the document created or modified, in order to extract identifiers from the document. The selected adapters will then analyze the contents associated with the document. At step 410, the selected adapter will emit document identifiers. At step 412, the document tracking agent 106 will send the document identifiers to the document tracker 108.

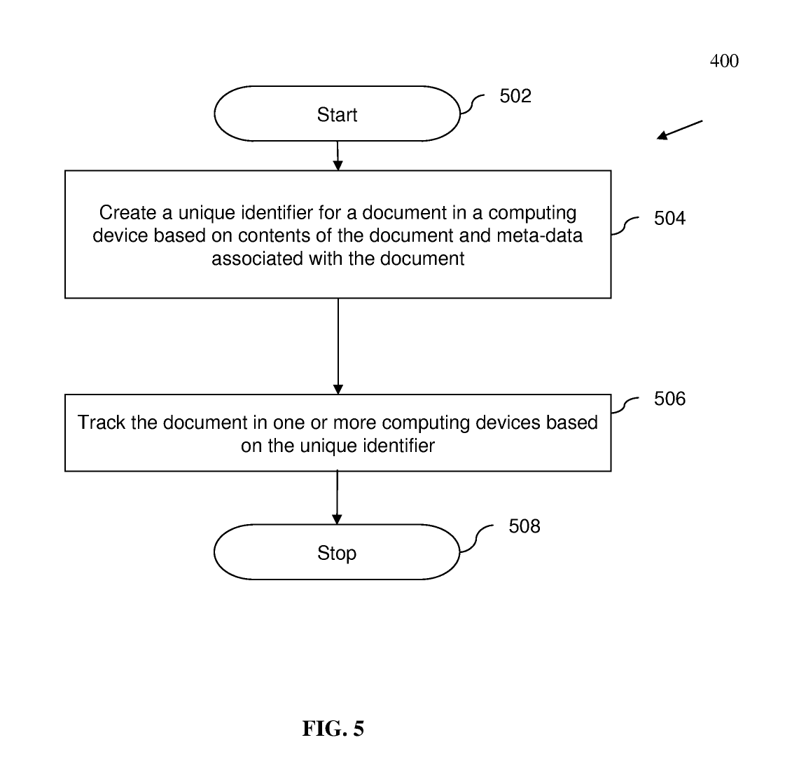

FIG. 5 illustrates a high level logic flowchart for tracking documents in a plurality of computing devices in accordance with one embodiment of the present invention. As illustrated, the method starts at step 502 and thereafter proceeds to step 504. At step 504, the method creates a unique identifier for a document in a computing device based on internal contents of the document and meta-data associated with the document. For example, in the environment 100, a unique identifier for the document 104 is created by the user computer 102 when the user creates the file 104 in the computing device 104. In an embodiment, the unique identifier is created in the computing device whenever a document is created in a computing device, modified in a computing device, shared with other computing devices, received from other computing devices, and/or sent to other computing devices. In an embodiment, a tracking agent, for example the tracking agent 106, creates the unique identifier associated with the document.

In an embodiment, the unique identifier along with version of the document and document author name is collected. In an embodiment, the unique identifier, version and the author details is collected by the document tracking agent 106 and is sent to a document tracker, for example the document tracker 108. In an embodiment, the document tracker is a separate computing and storage device. In another embodiment, the document tracker is a software module that is associated and installed in one or more computing devices. Similarly, the document tracking agent associated with each computing device keeps a track of the document's creation, modification and sharing and thereafter creates a unique identifier for the document. In an embodiment, the document tracking agent is a software module associated with each computing devices.

Hence, the document tracking agents associated with each computing device create unique identifiers and collect information about each computing device and each document that is created, modified, shared, received or sent by the computing devices. In an embodiment, the unique identifier is collected along with different version of the documents, properties associated with the document, and document author details. Examples of the properties associated with the document include document name, document author, document version, document location, and the like. At step 506, the document is tracked in one or more computing devices based on the unique identifier. In an embodiment, the method identifies the computing devices that are having the document based on the unique identifier created by each document. In an embodiment, the computing device creates the unique identifier using predefined rules, contents associated with the documents, and meta-data associated with the documents. Thus, the unique identifier created by each computing device will be similar for a same document.

In an embodiment, the computing devices that are having the document are associated with each other. For example, the one or more computing devices having the same document and different versions of the document are mapped based on unique identifiers created by the one or more computing devices. The mapping of one or more computing devices is explained in detailed in conjunction with FIG. 3. In an embodiment, the mapping is a graph like structure that represents the propagation of the document to one or more computing devices. In an embodiment, a network of interconnected documents in the plurality of computing devices is created based on the unique identifiers associated with the documents. Thus, all the computing devices having same documents or different versions of the documents are mapped with each other so that the document authors can track the propagation of the document and can identify the authors that have modified the document. At step 508, the method is terminated.

Various embodiments of the invention described above may provide at least, but are not limited to, a method for tracking documents in a plurality of computing devices. The method allows the author of a document to track the modifications made in the document by other users. The user can also track the propagation of the document within plurality of computing devices. The method provides information security and information isolation and redundancy as the changes made in the document can be tracked. Also, the method provides tracking of the document in a graph like structure that enables the users to quickly analyze and identify the users that are associated with the document and can also track the users that have modified the document.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, occur substantially concurrently, or the blocks may sometimes occur in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method for tracking documents in a plurality of computing devices, the method comprising:
creating a unique identifier for a document in a computing device based on contents of the document and meta-data associated with the document; and
tracking the document in one or more of the plurality of computing devices based on the unique identifier.

2. The method of claim 1, wherein the unique identifier is created in the computing device when the document is at least one of created, modified, and shared in the computing device.

3. The method of claim 1 further comprising collecting the unique identifier, properties associated with the document, and details of the document author in a document tracker, wherein the properties associated with the document is at least one of a document name, document author, document version, and document location.

4. The method of claim 1 further comprising associating the unique identifier with a user who currently possesses the document in a document tracker.

5. The method of claim 1, wherein tracking the document comprises identifying one or more computing devices from the plurality of computing devices having the document and different versions of the document based on the unique identifier created by the one or more computing devices.

6. The method of claim 5 further comprising mapping the one or more computing devices having the document and different versions of the document based on unique identifiers created by the one or more computing devices.

7. The method of claim 6 further comprising creating a network of interconnected documents in the plurality of computing devices based on the unique identifiers associated with the documents.

8. The method of claim 7 further comprising using user information associated with the unique identifiers for the network of interconnected documents to find all users who have the same document or versions of the same document

9. A computer system for tracking documents in a plurality of computing devices, the computer system comprising one or more processors including program instructions that are operable when executed by the computer system to:
create a unique identifier for a document in a computing device based on contents of the document and meta-data associated with the document; and
track the document in one or more of the plurality of computing devices based on the unique identifier.

10. The computer system of claim 9, wherein the unique identifier is created in the computing device when the document is at least one of created, modified, and shared in the computing device.

11. The computer system of claim 9, wherein the one or more processors include further instructions to collect the unique identifier, properties associated with the document, and details of the document author in a document tracker, wherein the properties associated with the document is at least one of a document name, document author, document version, and document location.

12. The computer system of claim 9, wherein the one or more processors include further instructions to identify one or more computing devices from the plurality of computing devices having the document and different version of the document based on the unique identifier created by the one or more computing devices.

13. The computer system of claim 12, wherein the one or more processors include further instructions to map the one or more computing devices having the document and different versions of the document based on unique identifiers created by the one or more computing devices.

14. The computer system of claim 9, wherein the one or more processors include further instructions to create a network of interconnected documents in the plurality of computing devices based on the unique identifiers associated with the documents.

15. A computer program product for tracking documents in a plurality of computing devices, the computer program product comprising:
one or more computer-readable tangible storage devices;
program instructions, stored on at least one of the one or more computer-readable tangible storage devices, to create a unique identifier for a document in a computing device based on contents of the document and meta-data associated with the document; and
program instructions, stored on at least one of the one or more computer-readable tangible storage devices, to track the document in one or more of the plurality of computing devices from the plurality of computing devices using the unique identifier.

16. The computer program product of claim 15, wherein the unique identifier is created in the computing device when the document is at least one of created, modified, shared, and deleted in the computing device.

17. The computer program product of claim 15, the computer program product further comprising program instructions, stored on at least one of the one or more computer-readable tangible storage devices, to collect the unique identifier, properties associated with the document, and details of the document author in a document tracker, wherein the properties associated with the document is at least one of a document name, document author, document version, and document location.

18. The computer program product of claim 15, further comprising program instructions, stored on at least one of the one or more computer-readable tangible storage devices, to identify one or more computing devices from the plurality of computing devices having the document and different versions of the document based on the unique identifier created by the one or more computing devices.

19. The computer program product of claim 18, further comprising program instructions, stored on at least one of the one or more computer-readable tangible storage devices, to create a relation between the one or more computing devices having the document and different versions of the document.

20. The computer program product of claim 18, further comprising program instructions, stored on at least one of the one or more computer-readable tangible storage devices, to create a network of interconnected documents in the plurality of computing devices based on the unique identifiers associated with the documents
